(19) United States
(12) Patent Application Publication
(10) Pub. No.: US 2013/0188391 A1
(43) Pub. Date: Jul. 25, 2013

(54) OPTICAL ARRANGEMENT

(71) Applicant: SeeReal Technologies S.A., Munsbach (LU)

(72) Inventor: Gerald FUTTERER, Dresden (DE)

(73) Assignee: SeeReal Technologies S.A., Munsbach (LU)

(21) Appl. No.: 13/739,323

(22) Filed: Jan. 11, 2013

(30) Foreign Application Priority Data
Jan. 11, 2012 (DE) 10 2012 100 205.3

(51) Int. Cl. F21V 8/00

(52) U.S. Cl. CPC G02B 6/0031
USPC 362/608; 362/611; 362/613

(57) ABSTRACT

The invention relates to an optical arrangement having a light source, which emits a beam, and having a light guide, which has a light-guiding layer, in which the coupled-in beam is guided between two substantially mutually opposite surface-type reflection layers. The optical arrangement is characterized in that the optical light paths of the individual rays of the beam, in particular at least of the marginal rays, from the light source to impingement on one of the reflection layers are substantially of equal length.

The invention relates to an optical arrangement having a light source, which emits a beam, and having a light guide, which has a light-guiding layer, in which the coupled-in beam is guided between two substantially mutually opposite surface-type reflection layers.

The invention also relates to an illumination apparatus, in particular to a background illumination apparatus for a display, in particular for a stereoscopic or holographic 3D display, having such an optical arrangement; and to a display having such an illumination apparatus.

Displays having surface-type, planar light guides for background illumination of a pixel matrix or of a controllable, spatial light modulator are known in various embodiments. In order to couple out the light propagating within the light guide, for example defects on one of the reflection layers may be provided.

Such an arrangement is known for example from the scientific publication “Short period holographic structures for backlight display applications”, Roberto Caputo at al., OPTICS EXPRESS 10540, volume 15, number 17.

US 2006/0279296 A1 discloses a background illumination unit for a flat-panel display. The background illumination unit has a light source and a light guide, in which coupled-in light is guided between two layers. One layer is a totally reflecting interface. The other layer is formed by a holographic grating having a specific grating structure, which in each case keeps part of the light in the light guide and in each case couples part of the light out of the light guide for illumination purposes. Similar arrangements are known from US 2004/0246743 A1 and from US 2006/0285185 A1.

The known types of background illumination have the disadvantage that, in particular in displays for producing a three-dimensional image, in particular in holographic displays, in which a coherent illumination of a pixel matrix or a controllable spatial light modulator is required, they cannot be used at all or only with insufficient result.

It is therefore the object of the present invention to specify an optical arrangement, which can be used for background illumination in displays for producing a three-dimensional image, in particular in holographic displays, without the three-dimensional image to be displayed being adversely affected.

The object is achieved by way of an optical arrangement, which is characterized in that the optical light paths of the individual rays of the beam, in particular at least of the marginal rays, from the light source to impingement on one of the reflection layers are substantially of equal length. Accordingly, means are provided which ensure that the optical light paths of the individual rays of the beam from the light source to impingement on one of the reflection layers are substantially of equal length.

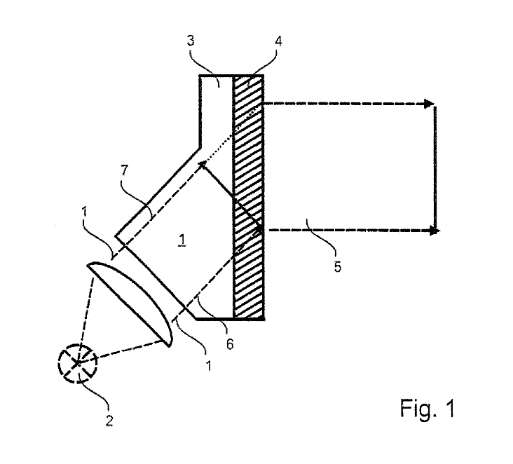

According to the invention, it has been found that errors in the representation in holographic images using the type of background illumination arrangements mentioned in the introduction can be attributed to the fact that the regions of a pixel matrix or of a controllable light modulator, which correspond to a sub-hologram of a hologram to be displayed, cannot be illuminated in a completely coherent manner. In particular if a collimated beam from a light source propagates obliquely to the light guide, that is to say at an angle with respect to the surface normal of the light guide that differs from 0° and from 90°, and is then coupled in, particular requirements with respect to the coherence length of the light emanating from the light source must be applied, which will be explained in more detail below with reference to FIG. 1:

FIG. 1 illustrates a collimated beam 1 from a light source 2 being coupled into a rear side of a planar surface-type light guide 3 and being coupled out of the light guide 3 using a coupling-out grating 4.

The beam 1 coupled into the light guide 3 impinges on the coupling-out grating 4, where part of the beam 1 is reflected (not shown) and another part is coupled out of the light guide 3 as a coupling-out beam 5. The reflected part of the beam 1 propagates up to the rear side of the light guide 3 (not shown), is totally reflected here and subsequently impinges again on the coupling-out grating 4 in order to be partially reflected here again and partially transmitted.

The part which is coupled out of the light guide 3 as coupling-out beam 5 with the aid of the coupling-out grating 4 upon initial impingement of the beam 1 is used to illuminate the region of a pixel matrix (not shown) or of a controllable light modulator, which corresponds to a sub-hologram. It has been found that a holographic image with good quality is possible only if this region is illuminated in a completely coherent manner, that is to say if in particular the marginal rays 6, 7 of the coupling-out beam 5 are coherent with respect to one another. According to the invention it has been found, however, that the marginal rays 6, 7 of the beam 1, when they impinge on a pixel matrix or on a controllable light modulator, have, in particular due to the coupling-in being at an oblique angle, traversed optical paths of different lengths. It has furthermore been found that therefore the coherence length of the beam emitted by the light source 2 must correspond at least to this difference in path length if a coherent illumination of a sub-hologram is to be ensured.

Taking into account a customary thickness of a surface-type light guide including coupling-out grating of a few millimetres and a customary diameter of a diffraction-limited laser beam of a commercially available laser, in particular a semiconductor laser, it has been found that the coherence length should be in the region of approximately 3 mm to 10 mm. As a result, only those lasers whose emission light is spectrally in a very narrow band can be used. Such lasers, in particular semiconductor lasers, are much more expensive and complicated than broadband lasers and therefore pose problems in particular with respect to mass production.

As already mentioned, it is advantageous in particular for illuminating a pixel matrix or a controllable light modulator if the optical arrangement is configured such that the beam emitted by the light source is at least sectionally collimated. In particular, a means for collimating the beam, in particular a lens or a lens arrangement, can be advantageously provided.

In a very particularly advantageous embodiment, a deflection means is provided on one of the reflection layers of the light guide, into which the beam is to be coupled, which deflection means receives the beam to be coupled in, deflects it and guides it into the light guide. In particular, the deflection means can be configured advantageously as a grating. It is particularly advantageous to configure the deflection means as a holographic grating. Such an embodiment can advantageously be produced not only inexpensively, but can also be produced so as to be matched individually to the respective boundary parameters of the optical arrangement. For example, the angle of the deflected light can be selected such that light can be coupled out from the light guide in a prescribed and/or homogeneous manner.

In one advantageous embodiment of the optical arrangement, the beam impinges perpendicularly with respect to the reflection layers of the light guide on the light guide or on the deflection means, which guides the beam into the light guide. This embodiment has the very particular advantage that different optical path lengths of the marginal rays are largely avoided.

Optical paths of the marginal rays having different lengths can be avoided for example by the marginal rays—unlike the case in the arrangement illustrated in FIG. 1—always propagating parallel with respect to one another and, in the process, traveling substantially identical optical paths, without any of the marginal rays already being diffracted or refracted into a different direction while the other marginal ray continues to propagate in the original direction. However, it is also possible to allow in one section initially a path-length difference of the rays of the beam, in particular of the marginal rays, but to compensate said difference in a subsequent section. The latter can be realized advantageously in particular by the beam path of the beam—at least sectionally—being folded symmetrically, in particular with point or mirror symmetry.

In one advantageous embodiment of the optical arrangement, provision is made for the beam inside the light guide to impinge alternately on the surface-type reflection surfaces, wherein the beam, starting from one of the reflection surfaces up to the next impingement on the same reflection surface, travels a particular optical path which is longer than the coherence length of the beam emitted by the light source. This embodiment has the very particular advantage that no undesired interference effects occur if neighboring beams, which are coupled out of the light guide, spatially superpose one another. Use is made here of the fact that in the superposition region temporally persistent interference effects, such as cancelation or amplification, which can manifest for example as diffraction patterns, occur only if the parts of the coupled-out coupling-out beams which undergo superposition have a temporally fixed phase relationship with respect to one another. However, this will be possible only if the abovementioned optical path is not longer, but shorter than the coherence length of the beam emitted by the light source.

With respect to the use of the optical arrangement according to the invention in a holographic display, the advantage is that neighboring sub-holograms can certainly partially overlap spatially without disturbing artefacts occurring. In particular, it is therefore advantageously possible to do away with the provision of a spacing between the sub-holograms which could possibly itself be a cause of disturbing artefacts.

As already explained, provision may already be made advantageously for at least one of the reflection surfaces of the light guide to be configured for reflecting in each case only one part of the beam and/or of the further beam and for transmitting the other part of the beam out of the light guide. In order to enable coupling out, one of the reflection surfaces may, for example, have defects. Provision may also be made for a hologram to be arranged on one of the reflection surfaces or for one of the reflection surfaces itself to be configured as a hologram.

Provision may in particular be made for the reflection surface, through which no light is intended to be coupled out, to be configured as a totally reflecting surface. Alternatively, it is also possible for this reflection surface to be provided with a mirror coating, in particular a dielectric mirror coating.

In a very particularly advantageous embodiment, at least one further light source is provided, which emits a further beam, which is coupled into the light guide such that the optical light paths of the individual rays of the further beam, in particular of at least the marginal rays, from the further light source up to impingement on one of the reflection layers to be of substantially equal length. This embodiment has the particular advantage that the surface-type light guide can basically be configured to have an arbitrary size, without the intensity of the coupled-out light being significantly reduced far off a first light source.

In particular, a light guide can advantageously be fed a multiplicity of mutually spaced-apart beams, which are coupled into the light guide. Here, the beams can in particular impinge, in a row with preferably equidistant spacings, on the light guide or in each case on a deflection means for coupling light into the light guide. Alternatively or additionally, it is also possible for the light guide to be fed beams which are coupled into the light guide, which beams are arranged with respect to one another in the manner of a matrix and, and/or for the light guide to have a matrix of deflection means for coupling in the beams.

In a very particularly advantageous embodiment, the optical arrangement has a multiplicity of light sources for producing a multiplicity of beams, which can be coupled into the light guide in particular as described above. In particular, provision may advantageously be made for the individual light sources to be switched on or off as required during use of the optical arrangement having such a configuration in a holographic display in dependence on the image to be displayed, or for its light output to be individually controlled in dependence on the holographic image to be displayed in each case with regard to the light output.

In the present case, preferably at least one further light source is provided, which emits a further beam, which is coupled into the light guide such that the optical light paths of the individual rays of the further beam, in particular of at least the marginal rays, from the further light source up to impingement on one of the reflection layers are of substantially equal length.

A further deflection means, which receives the beam to be coupled in, deflects it and guides it into the light guide, could be provided on one of the reflection layers of a light guide into which the further beam is to be coupled. Alternatively or additionally, a further deflection means could be provided on one of the reflection layers, which further deflection means receives the beam propagating perpendicularly to the reflection layers, deflects it and guides it into the light guide.

Provision is made in one advantageous embodiment for the beam and the further beam to propagate parallel to one another. When using a multiplicity of light sources which, for example, are arranged in rows and/or in the manner of a matrix, provision may likewise be made for the individual beams emitted by the light sources to propagate parallel with respect to one another.

Provision may in particular advantageously be made for the optical arrangement to have a multiplicity of identically constructed and identically aligned light sources and/or of identically constructed and identically aligned means for collimating and/or of identically constructed and identically aligned deflection means. To this extent, for example one and the same surface-type light guide can be provided, for example, with a multiplicity of identically constructed illumination modules—which are arranged in particular in the manner of a matrix—, each of which has a light source for producing a beam to be coupled in and/or a deflection means for coupling in and/or a means for collimating. These illumination modules are preferably arranged on or adjacent to the reflection layer which is located opposite the reflection layer through which the illumination light is coupled out of the light guide.

The optical arrangement according to the invention as claimed in one of claims 1 to 10 is preferably used for an illumination apparatus. Here, the illumination apparatus could be configured in form of a background illumination apparatus—in particular for a display—, that is to say could illuminate a controllable spatial light modulator working in transmission mode from a side of the light modulator that is remote from the observer. The display could be a stereoscopic or holographic 3D display.

Furthermore, the optical arrangement according to the invention as claimed in one of claims 1 to 10 and/or the illumination apparatus as claimed in claim 11 could be used for a display. The display could be a 3D display, in particular a stereoscopic or holographic 3D display.

The drawing schematically illustrates the subject matter of the invention and will be explained below with reference to the figures, wherein identical or identically functioning elements are generally provided with the same reference numerals. In the figures:

FIG. 1 shows an optical arrangement—not according to the invention—for illustrating in particular the difficulties when being used in a holographic display,

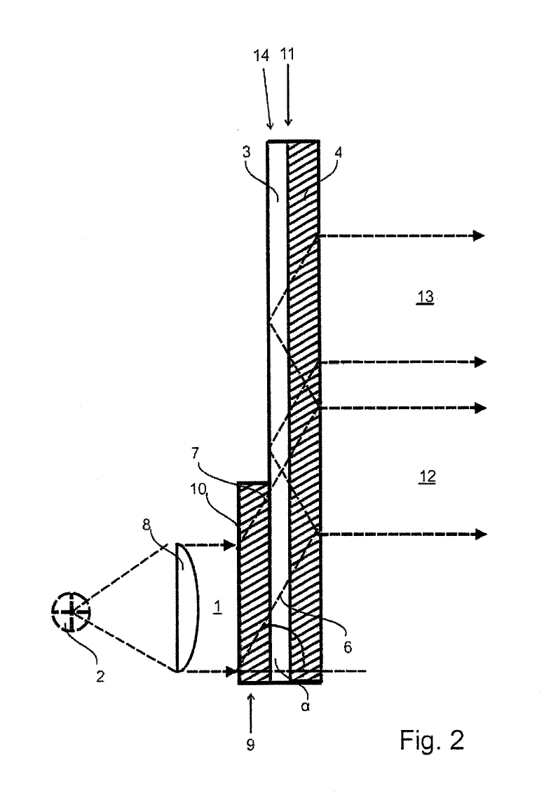

FIG. 2 shows a schematic side view of an exemplary embodiment of an optical arrangement according to the invention and

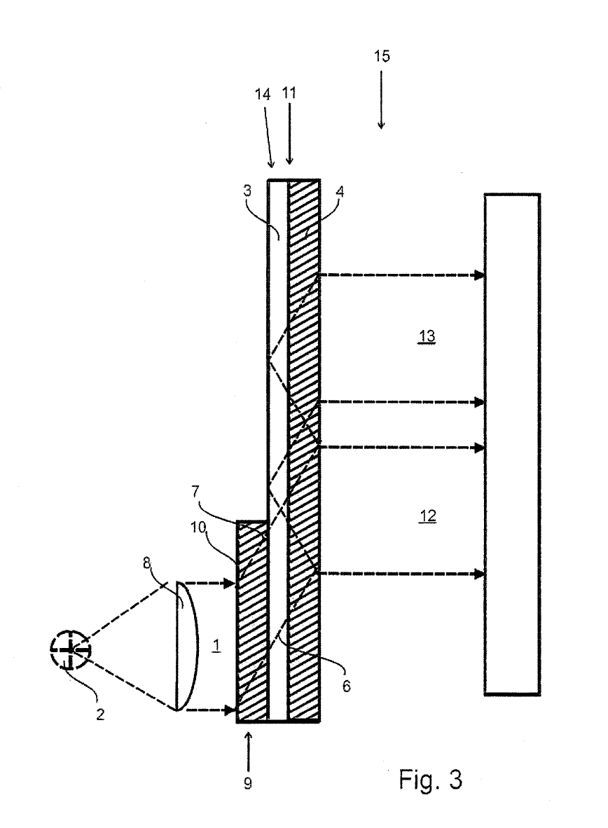

FIG. 3 schematically shows a display for holographic representation with an optical arrangement according to the invention.

The construction of the optical arrangement shown in FIG. 1 is already explained in more detail further above. The optical arrangement according to the invention, which is illustrated in FIG. 2, differs from the former optical arrangement in particular in that the light paths of the marginal rays 6, 7 of the beam 1 collimated with a lens 8 propagate identically and always parallel to one another. This is achieved, inter alia, by the collimated beam 1 impinging perpendicularly on a deflection means 9, which is arranged directly on the light guide 3 and receives the beam 1 to be coupled in, deflects it and guides it into the light guide 3. The deflection means 9 is configured as a holographic grating 10 and deflects the rays of the collimated beam by the angle a. The symmetry between deflection means 9 and coupling-out grating 4 enables light of reduced temporal and spatial coherence to be used. Deflection means 9 and coupling-out grating 4 can be configured as transmission elements and/or as reflection elements.

FIG. 2 illustrates that the beam 1 that is coupled in by the deflection means 9 initially impinges on a first reflection surface 11, which is provided with a coupling-out grating 4, which can be configured in particular as a holographic coupling-out grating. Part of the beam 1 is reflected; another part is coupled out of the light guide 3 as a first coupling-out beam 12. The reflected part of the beam 1 passes to the second reflection surface 14, is totally reflected here and passes back to the first reflection surface 11, where a second coupling-out beam 13 is coupled out.

FIG. 2 shows that the first coupling-out beam 12 and the second coupling-out beam 13 overlap somewhat. The difference in optical path length of the second coupling-out beam 13 relative to the first coupling-out beam 12, however, is longer—in particular due to the targeted selection of the dimensions and angles—than the coherence length of the beam 1 emitted by the light source 2, with the result that no disturbing interference artefacts, such as for example disturbing diffraction patterns, occur in the overlap region.

FIG. 3 schematically shows a display 15 for holographic representation having an optical arrangement 16 according to the invention and having a controllable, spatial light modulator 17, which is illuminated with the optical arrangement 16 according to the invention.

The invention was described with reference to a particular embodiment. It is to be understood, however, that modifications and variations can be carried out without departing the scope of protection of the following claims.

1. An optical arrangement having a light source, which emits a beam, and having a light guide, which has a light-guiding layer, in which a coupled-in beam is guided between two substantially mutually opposite surface-type reflection layers, wherein the optical light paths of the individual rays of the beam, in particular at least of the marginal rays, from the light source to impingement on one of the reflection layers are substantially of equal length.

2. The optical arrangement as claimed in claim 1, wherein the beam is at least sectionally collimated and/or that a means for collimating the beam is provided.

3. The optical arrangement as claimed in claim 1, wherein a deflection means is provided on one of the reflection layers of a light guide, into which the beam is to be coupled, which deflection means receives the beam to be coupled in, deflects it and guides it into the light guide and/or wherein a deflection means is provided on one of the reflection layers, which deflection means receives the beam propagating perpendicularly to the reflection layers, deflects it and guides it into the light guide.

4. The optical arrangement as claimed in claim 1, wherein the light beam inside the light guide impinges alternately on the surface-type reflection surfaces, wherein the beam, starting from one of the reflection surfaces up to the next impingement on the same reflection surface, travels a particular optical path which is longer than the coherence length of the beam emitted by the light source.

5. The optical arrangement as claimed in claim 1, wherein at least one further light source is provided, which emits a further beam, which is coupled into the light guide such that the optical light paths of the individual rays of the further beam or of at least the marginal rays, from the further light source up to impingement on one of the reflection layers are of substantially equal length.

6. The optical arrangement as claimed in claim 5, wherein the beam and the further beam propagate parallel to each other.

7. The optical arrangement as claimed in claim 5, wherein a further deflection means, which receives the beam to be coupled in, deflects it and guides it into a light guide, is provided on one of the reflection layers of the light guide into which the further beam is to be coupled and/or wherein a further deflection means is provided on one of the reflection layers, which further deflection means receives the beam propagating perpendicularly to the reflection layers, deflects it and guides it into the light guide.

8. The optical arrangement as claimed in claim 4, wherein the deflection means or the further deflection means or the deflection means and the further deflection means is/are configured as at least one of a grating and/or as a holographic grating.

9. The optical arrangement as claimed in claim 1, wherein at least one of the reflection surfaces is configured for reflecting in each case only one part of the beam or of the further beam or of the beam and of the further beam and for transmitting the other part of the beam out of the light guide.

10. The optical arrangement as claimed in claim 1, wherein the beam path of the beam or of the further beam or of the beam and of the further beam—at least sectionally or between the light source and the light guide—is folded symmetrically or is folded symmetrically with point or mirror symmetry.

11. An illumination apparatus or a background illumination apparatus for a display or for a stereoscopic 3D display or for a holographic 3D display, having an optical arrangement as claimed in claim 1.

12. A display or a 3D display or a stereoscopic 3D display or a holographic 3D display, having at least one illumination apparatus as claimed in claim 11.

13. A display or a 3D display or a stereoscopic 3D display or a holographic 3D display, having at least one optical arrangement as claimed in claim 1.
